(19) United States
(12) Patent Application Publication
(10) Pub. No.: US 2001/0030055 A1
(43) Pub. Date: Oct. 18, 2001

(54) Patch cable with long term attenuation stability

(76) Inventor: Jorg-Hein Walling, Beaconsfield (CA)

Correspondence Address: Gary S. Engelson, Wolf, Greenfield & Sacks, P.C., 600 Atlantic Avenue, Boston, MA, 02210, US

(21) Appl. No.: 09/755,601

(22) Filed: Jan. 5, 2001

Related U.S. Application Data
(60) Provisional application No. 60/174,516, filed on Jan. 5, 2000.

(51) Int. Cl. H01B 5/08

(52) U.S. Cl. 174/128.1

(57) ABSTRACT

A patch cable having better stability of electrical parameters, particularly attenuation, includes a stranded conductor to which a polymeric material is bonded, filling interstices occurring peripherally about the stranded conductor. Insulation is bonded to the polymeric material. Pairs of such insulated conductors are twisted together and terminated by an RJ-45 type connector or the like in typical applications.

### BACKGROUND

1. Field of the Invention

The invention relates to constructions of patch cables and patch cords. More particularly, the invention relates to constructions, which improve the stability of patch cable and patch cord electrical characteristics over time.

2. Related Art

Patch cables are usually multiple twisted pair cables conventionally terminated using RJ-45 or similar connectors referred to hereinafter as RJ-45 type connectors. If the patch cable includes such a connector, it is generally referred to as a patch cord. Patch cords can connect a wall outlet to equipment. They can also connect different pieces of equipment in the equipment room itself. Patch cables and patch cords generally have 4 pairs, but it is also possible to use either less or more pairs.

Recently, some reports have been published on the subject of “aging” of patch cables. Aging refers to an attenuation increase over time. Attenuation is an electrical parameter of cable performance, which defines by how much a signal transmitted through the cable is made weaker or attenuated.

Patch cables are generally made with stranded conductors, e.g., either 7-strand or 19-strand conductors. Stranded conductors enhance flexibility of the patch cords, which otherwise may break due to repetitive flexing.

Moisture infiltration is one cause of attenuation increase. In order to explain the effect of moisture upon attenuation increase, the manufacturing methods of the conductors used to make the pairs for the patch cable should be considered. Insulation is generally applied by extrusion, either by a tubing process (see FIG. 1), semi-crush extrusion (see FIG. 2), or by crush extrusion (also referred to as pressure extrusion, see FIG. 3). Varying degrees of conformance between the insulation and a 7-strand conductor are shown in FIGS. 1, 2 and 3, respectively. However, the crush extrusion as shown in FIG. 3, can in reality not be obtained. The main reason is the compounds, which are suitable for use as insulation exhibit relatively high viscosity at the temperatures and pressures present at the exit of the extruder. Therefore practical cable constructions resemble the conditions shown in FIG. 2 for semi-crush extrusion, but with slightly deeper penetration of the compound into the space in between each two wires, forming the conductor strand.

As noted above, FIG. 1 shows a tubed cable construction. The illustrated cable 100 includes seven strands 101 in each conductor 102. The cable 100 includes two such conductors 102. Each conductor 102 is surrounded by a tubular form of insulation 103. Such a construction leaves large interstices 104 between the insulation 103 and the strands 101 of the conductors 102.

The semi-crushed insulation cable 200 of FIG. 2 has conductors 102 formed of strands 101, as in FIG. 1. However, insulation 201 is forced by the pressure of extrusion to reduce the size of interstices 202 relative to interstices 104.

A fully crushed insulation cable 300, as shown in FIG. 3, also has conductors 102 formed of strands 101. In this construction, the extrusion pressure is arranged and directed to force the insulation 301 adjacent the strands 101, leaving no interstices between insulation 301 and strands 101.

Moisture pick-up occurs through permeation of the water vapor through the jacket material and the insulation. If there are voids at the conductor-insulation interface, then the water vapor will condense and accumulate as liquid in these voids. The areas 401 where moisture may accumulate are indicated in FIG. 4. Accumulation of water in the peripheral interstices 401 principally causes the attenuation increase. Water accumulation inside the conductors 102, i.e. in the interstices (e.g., FIG. 4, 402) between the central inner conductor 102 and the surrounding conductors 102 does not have any detrimental impact upon the attenuation, as long as it remains contained inside this region.

However, areas 402 contribute to the pumping action. This phenomenon is well known in the cable industry, if cables are exposed to varying temperatures. Under these circumstances, water permeating through the jacket is accumulating by condensation over time inside the cable. This moisture is normally adsorbed at the inner surfaces of the compound, and the outer surfaces of the conductors. This amount of water is very small, yet as it forms a continuous layer it has a detrimental impact on the electrical performance.

Additionally, if the water-ingress by permeation is very high, such that there is an accumulation of free water, then it may be distributed longitudinally within the cable. This is, under these circumstances, substantially enhanced by capillary action along the crevices formed by the conductors and the compound.

As shown in FIG. 5, it has been clearly established by the inventor, that increasing attenuation over time is essentially due to moisture pick-up. The figure graphs attenuation against frequency under four conditions: a maximum attenuation limit beyond which performance is unacceptable, line 501; a typical cable immediately after manufacture, line 502; the same cable after four months of use, line 503; and the used cable after drying at 60° C. for 48 hours, line 504. This figure clearly indicates that proper drying can partially reverse the effect of the water pickup. This reversal is not, however, 100% effective. It could be, therefore, argued, that the effect is not entirely reversible. However, these discrepancies are explainable by plasticizer migration from the jacket into the insulation material. It is well known, that the jacket plasticizer, when it migrates into the insulation, has a very detrimental effect upon attenuation. This plasticizer migration takes place normally only at elevated temperatures, for example the temperatures applied here for drying the cable (60° C. for 48 Hrs.). Generally patch cords are not exposed to such elevated temperatures.

During the twisting operation in which the stranded conductors 102 are manufactured, each conductor 102 is torsioned individually. That opens up the interface between insulation 201 and conductor 102, where normally the insulation 201 and the conductor 102 should be in close contact to avoid water accumulation. This is indicated in FIG. 4, showing the areas 401 and surfaces 403 where water may accumulate and the interfaces where moisture may penetrate.

This opening is exacerbated by the different mechanical properties of the insulation 201 and the conductors 102 under torsion. Additionally, as the conductors 102 are stranded, this torsioning during twisting may increase or decrease the strand lay of each individual conductor 102. A shortening of the strand lay is generally not advisable, i.e. the strand lay of the conductors should be selected such that it is, combined with the additional torsion due to the twisting, not smaller than approximately ½ inch.

The torsion angle of the individual conductors 102 in a double-twist twister is generally in the order of 50% of that of the twist itself. This depends upon the surface roughness or friction between both conductors, and may result in values slightly higher than 50%. Hence, using a suitable percentage of back torsioning of both conductors 102 yields twisted conductors 102, where the strand lay of the conductors 102 can be perfectly well maintained. However, even in case of back torsioning of both conductor by 50% relative to the twistlay, yields a partial lift off of the insulation 201 of the stranded conductor 102, and creates crevices. Onto the surfaces such created water may adsorb, and may depending upon quantity even ingress further by capillary action.

One attempt to solve the foregoing problems is disclosed in U.S. Pat. No. 5,763,823, issued Jun. 9, 1998. However, this patent is limited to tinned conductors 102 only. Here a slight improvement of the attenuation behavior is obtained by passing the tinned and stranded conductors 102 again through a tinning bath. This yields a partial filling of the interstices and a cold soldering of the stranded conductors. A substantial disadvantage of the technology disclosed in U.S. Pat. No. 5,763,823 is that it is only applicable to twisted pairs which are manufactured by a simultaneous insulation process of both conductors 102 of a pair, bonding the conductors 102 together. Bonded conductors are protected and restricted by the bonding from undergoing movement of individual strands relative to each other in the subsequent twisting operation. The overtinning process does not yield the desired results, if the conductors are stressed in such a manner as to cause relative movement between individual strands thereof. In this case the bond created by the tin overcoat is broken, and will always leave detrimental crevices.

Another solution to the above problem would be to coat the conductors with a hydrophobic material, which could be applied during the stranding operation of the conductors or afterwards, provided the viscosity of the material used for the purpose is sufficiently low. A possible material for this purpose is silicone oil or silicone grease. However, coating with such a material on the conductors can cause difficulties during the subsequent insulating process, as it would be very hard to get sufficient adhesion between the insulating material and the conductor at the exit of the extruder. Additionally, crevice formation during the twisting operation cannot be avoided. Hence, only a partial success to avoid water induced attenuation increase due to humidity pick-up will be achieved.

### SUMMARY OF THE INVENTION

It is an object of the present invention to overcome the detrimental effects of water penetration into the conductors of stranded patch cords.

A solution embodying aspects of the invention uses a suitable polymeric material, having a sufficiently low viscosity, to deeply penetrate the stranded conductor during application. The application of this polymeric material should preferably be done under higher pressures. A further option is to select a polymeric material, which creates a physical bond between the insulting material and the conductors during and after the extrusion process of the insulation and the stranded conductors.

According to one embodiment of the invention, there is provided an insulated, stranded conductor, comprising: a multi-strand conductor having interstices defined between strands; a solid filler material penetrating the interstices of the multi-strand conductor and adhering thereto; and a layer of insulating material coating and adhering to the multi-strand conductor and solid filler material. Optionally, the insulated, stranded conductor may be incorporated in a patch cable together with another insulated conductor twisted with the insulated, stranded conductor as a twisted pair. In yet another optional construction of the conductor, the solid filler material is a polymer. The polymer may be flowable under the influence of extrusion heat/pressure conditions. Also, the polymer may be a different material than the layer of insulating material.

### BRIEF DESCRIPTION OF THE DRAWINGS

In the drawings, in which like reference designations indicate like elements:

FIG. 1 is a cross-sectional view of a stranded pair with tubed insulation;

FIG. 2 is a cross-sectional view of a stranded pair with semi-crushed insulation;

FIG. 3 is a cross-sectional view of a stranded pair with fully-crushed insulation;

FIG. 4 is an enlarged cross-sectional view of one conductor of the pair of FIG. 2; and

FIG. 5 is a graph of attenuation versus frequency for a cable under varying conditions.

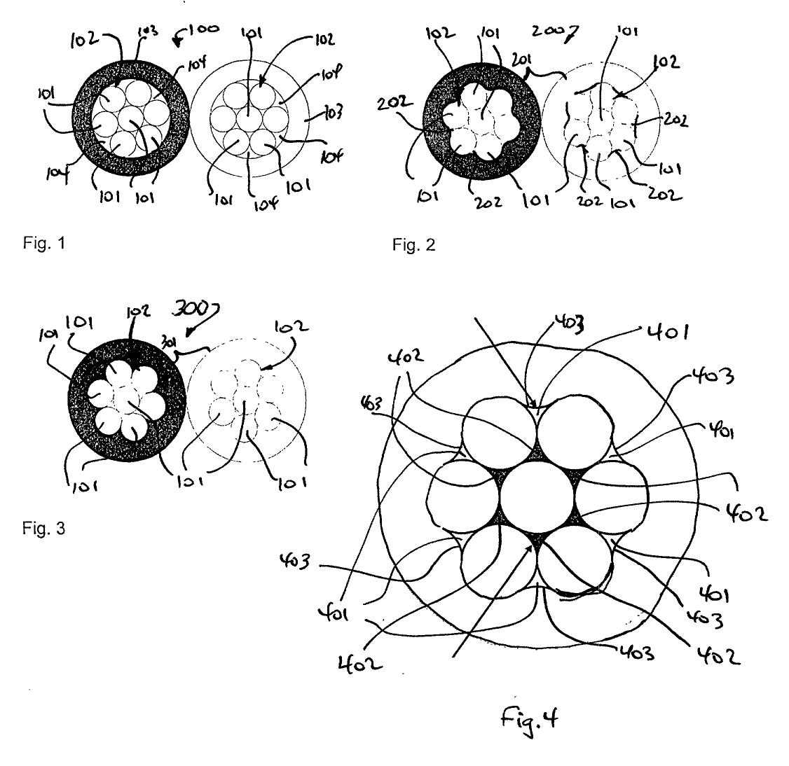

### DETAILED DESCRIPTION

The exemplary embodiments of the invention illustrated herein are flexible conductors and patch cables made therefrom, conventionally terminated by RJ-45 connectors or the like. Patch cables may now or in the future be terminated using other connector styles, meant to be encompassed by this disclosure.

Flexible conductors embodying aspects of the invention include stranded conductors, e.g., either 7-strand or 19-strand conductors, to enhance flexibility without breakage. As discussed above, stranded conductors include peripheral interstices.

Embodiments of the invention preferably nearly completely fill the peripheral interstices with a polymeric material, which is bonded both to the conductor and the insulation. A high degree of fill is achieved, using a filling temperature, suitable for the hot-melt-compound (generally in the order of 100-150 /C). The hot-melt material furthermore penetrates even deeper in between the conductors forming the strand by the consecutive extrusion of the insulation, which takes place generally at temperatures between 200 and 230 /C at pressures in the order of 3500 to 4500 psi.

The polymeric material should be one, which has at application temperature a high meltflow, in the order of 80 gr/10 min and above. Examples of suitable materials for bonding the insulation to the conductors are EVA (Ethylene-vinyl-acetate) and EAA (Ethylene-acrylic-acid). These materials are generally cost-prohibitive to be used directly as insulating compound, and have furthermore not the required electrical characteristics.

However, it is also feasible to modify the Polyethylene-insulating compound with maleic or acrylic acid, such that the compound itself adheres strongly to the conductor, without the need of any additional adhesive.

Therefore, embodiments of the invention further have an outer layer of insulation, formed of polyolefin for example.

This yields, with a proper lay out of the tooling, relative high pressures, thus ensuring that the low viscosity polymeric materials or hot-melts penetrate deep into the interstices of the wires forming the strand.

Embodiments of the invention have very negligible areas where moisture can accumulate, and these very small areas are distant from the outer diameter of the stranded conductor. In fact, these voids are located nearly half the diameter of the individual wires making up the strand from the outer diameter of the stranded wire. Due to this increased distance from the outer periphery of the stranded conductors they also have very little influence upon the electrical transmission performance of the patch cable, even if they are accumulating water inside. The voids can fill out the entire shape indicated by 402 in FIG. 4.

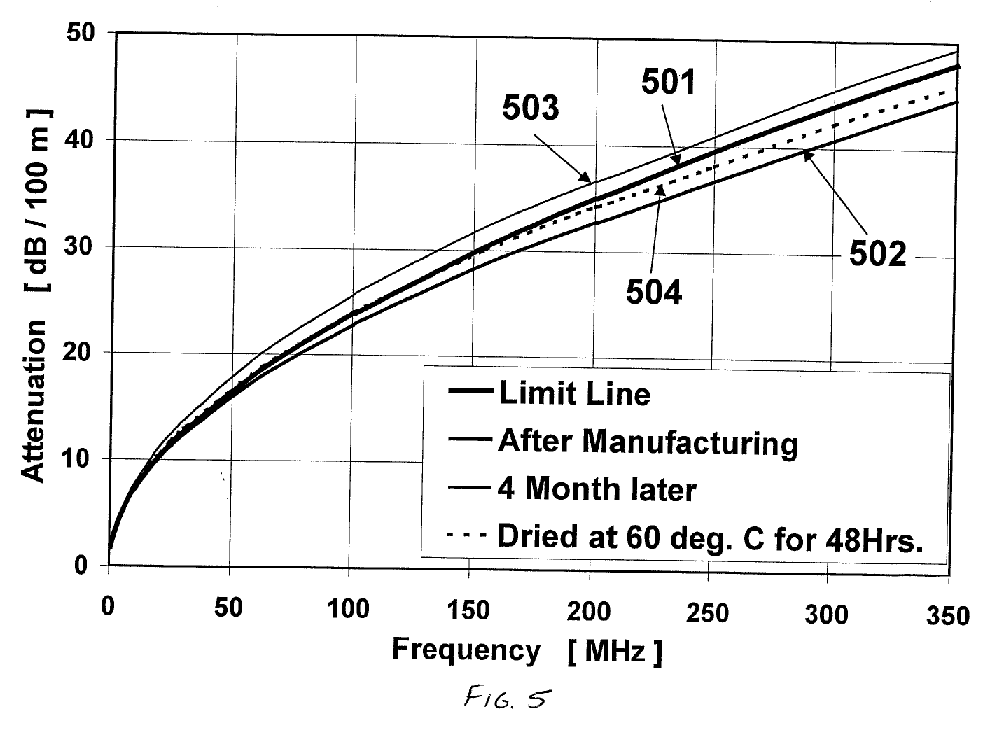

Embodiments of the invention are further characterized by a composite structure of the stranded wire and the insulation. The structure is more fully integrated, more closely resembling that of the fully crushed example of FIG. 3. The result of such a composite structure is that each wire is integrally torsioned during the twisting operation. This avoids the creation of crevices at the interface between conductor and insulation. In accordance with embodiments of the invention there is a possibility of maintaining the original strand lay of the stranded conductors, even after twisting, provided a suitable degree of back torsioning is selected for both conductors forming a pair.

Such a patch cable construction is characterized by slightly stiffer twisted pairs than conventional patch cables. However the resistance against repetitive bending remains about the same. Bonded insulations according to aspects of the invention can be difficult or impossible to strip. However, strippability is not a requirement because termination can be done using insulation displacement connectors or terminals.

The present invention has now been described in connection with a number of specific embodiments thereof. However, numerous modifications, which are contemplated as falling within the scope of the present invention, should now be apparent to those skilled in the art. Therefore, it is intended that the scope of the present invention be limited only by the scope of the claims appended hereto.

What is claimed is:

1. An insulated, stranded conductor, comprising:
a multi-strand conductor having interstices defined between strands;
a solid filler material penetrating the interstices of the multi-strand conductor and adhering thereto; and
a layer of insulating material coating and adhering to the multi-strand conductor and solid filler material.

2. The insulated, stranded conductor of claim 1, incorporated in a patch cable, the patch cable further comprising:
another insulated conductor twisted with the insulated, stranded conductor as a twisted pair.

3. The conductor of claim 1, wherein the solid filler material is a polymer.

4. The conductor of claim 3, wherein the polymer is flowable under the influence of extrusion heat/pressure conditions.

5. The conductor of claim 4, wherein the polymer is a different material than the layer of insulating material.
